(19) United States
(12) Patent Application Publication
(10) Pub. No.: US 2026/0087326 A1
(43) Pub. Date: Mar. 26, 2026

(54) GENERATING SYNTHETIC DATA

(71) Applicant: RUTGERS, THE STATE UNIVERSITY OF NEW JERSEY, New Brunswick, NJ (US)

(72) Inventors: Xinyue WANG, Newark, NJ (US); Hafiz ASIF, Newark, NJ (US); Jaideep VAIDYA, Newark, NJ (US)

(21) Appl. No.: 19/111,047

(22) PCT Filed: Sep. 11, 2023
(86) PCT No.: PCT/US2023/032411

§ 371 Date: Mar. 12, 2025

Related U.S. Application Data
(60) Provisional application No. 63/405,687, filed on Sep. 12, 2022.

(51) Int. Cl. G06N 3/0475; G06F 18/214; G06N 3/09

(52) U.S. Cl. CPC G06N 3/0475; G06F 18/214; G06N 3/09

(57) ABSTRACT

Techniques and systems for generating synthetic data 200 are described. The described techniques and systems provide realistic synthetic data by preserving observable and missing data distributions. A method of generating synthetic data includes receiving data having missing elements having missing elements; evaluating the data for patterns with respect to the missing elements; labeling the data according to the patterns; generating labeled synthetic data using the labeled data; and inserting blanks into the labeled synthetic data according to associated labels of the labeled data to generate synthetic data with corresponding missing elements.

### CROSS-REFERENCE TO RELATED APPLICATION(S)

This application claims the benefit of U.S. provisional application Ser. No. 63/405,687, filed Sep. 12, 2022, which is hereby incorporated by reference in its entirety, including figures, tables, and appendix.

This invention was made with Government support under Federal Grant nos. R35-GM134927 awarded by the National Institutes of Health. The Federal Government has certain rights to this invention.

### BACKGROUND

The use of synthetic datasets, as a substitute for real data, has become widespread in many settings. Synthetically generated data emulates the key information in the actual data and is used—with or without the actual data—to draw valid statistical inferences. For instance, synthetic datasets are used to make sensitive data available for public and research while maintaining the privacy of the individuals' (e.g., patients') information or to even augment actual data when the available actual data is insufficient for machine learning and data mining.

### BRIEF SUMMARY

Techniques and systems for generating synthetic data are described. The described techniques and systems provide realistic synthetic data by preserving observable and missing data distributions.

A method of generating synthetic data includes receiving data having missing elements; evaluating the data for patterns with respect to the missing elements; labeling the data according to the patterns; generating labeled synthetic data using the labeled data; and inserting blanks into the labeled synthetic data according to associated labels of the labeled data to generate synthetic data with corresponding missing elements.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in which various embodiments of the invention may be practiced.

FIG. 2 illustrates an example process for generating synthetic data according to certain embodiments of the invention.

FIG. 3 illustrates an example implementation of generating synthetic data.

FIGS. 4A and 4B illustrate an example synthetic data prediction engine, where FIG. 4A shows a process flow for generating models and FIG. 4B shows a process flow for operation.

FIG. 5A illustrates details of a general MergeGEN algorithm used to generate synthetic data according to certain embodiments of the invention.

FIG. 5B illustrates a pictorial overview of the MergeGEN algorithm described in FIG. 5A.

FIG. 6A illustrates details of a general HottGEN algorithm used to generate synthetic data according to certain embodiments of the invention.

FIG. 6B illustrates a pictorial overview of the HottGEN algorithm described in FIG. 6A.

FIGS. 7A and 7B illustrate components of example computing systems that may carry out the described processes.

FIGS. 8A-8D depict synthetic data quality of the Gauss 1 dataset, showing comparative plots of the different instantiated methods with respect to similarity S, divergence in mp-distribution Dₘᵢₛ, relative error of mean (REM), and standard deviation (RESD) of the synthetic dataset.

FIG. 9 illustrates a table depicting synthetic data quality for the Gauss 2 dataset.

FIGS. 10A and 10B show t-SNE plots for the Gauss 1 and Gauss 2 datasets for each method and dataset that is given by quantile.

FIGS. 11A-11E depict synthetic data quality of the Gauss 3 dataset, showing comparative plots of the different instantiated methods with respect to similarity S, divergence in mp-distribution Dₘᵢₛ, PCD, REM, and RESD.

FIG. 12 illustrates a t-SNE Plot obtained from the various instantiated methods for the Price dataset (a) and Brain dataset (b).

FIG. 13 illustrates a table depicting synthetic data quality obtained from the various instantiated methods for the Price dataset (a) and Brain dataset (b).

### DETAILED DESCRIPTION

Techniques and systems for generating synthetic data are described. The described techniques and systems provide realistic synthetic data by preserving observable and missing data distributions.

Synthetic data is only useful if it is realistic e.g., it mimics the real data and provides similar statistical results. Typically, in industry and in research, the methods of generating synthetic data (or of general data analysis and machine learning) work over the data with no missing values (i.e., complete data). Real data, however, is often incomplete, where the real data consists of missing values. While real data often has missing values, existing synthetic data generation methods include solutions to ‘eliminate’ missing data: either by complete-case analysis (i.e., eliminating samples with missing values) or by impute-and-generate method (i.e., imputing missing values and then using the data). ‘Elimination’ as the only approach to deal with missing data fails to leverage the useful information that missing data captures. This is because, in many practical settings, the missing values are not due to some data-independent (e.g., Missing Completely at Random (MCAR)) mechanism. Instead, missing values are often due to underlying data-dependent mechanisms (e.g., Missing at Random (MAR) and Missing Not at Random (MNAR)) that capture complex situational or environmental interactions. Therefore, the complete-case analysis is unfit for all the real-life situations where missing values in the data are due to MAR and MNAR mechanisms.

Although the impute-and-generate method makes a better use of the observable data, the impute-and-generate method hides all the missing information, for example from the researcher who receives the synthetic data for analysis. Thus, the impute-and-generate method takes away any opportunity to utilize domain expertise or additional or auxiliary information that the researcher may have to perform a better imputation or even use the missing data explicitly in the models to improve the analysis results. Thus, in both the cases (the complete-case analysis and the impute-and-generate method), the synthetic data distribution can fail to mimic the real data.

Missing data (e.g., missingness) is often an integral part of the data and conveys significant information about the underlying population or data collection (or data generation) mechanism, which would be lost if one used the ‘elimination’ approach. Thus, if the underlying real data has missing values, to be realistic, the corresponding synthetic data must have missing values as well so that the synthetic data matches real data with respect to observable data distribution and missing data distribution.

A challenge in achieving this realistic synthetic data is to be able to either explicitly or implicitly model, learn, and sample from the joint distribution of the observable and missing data. This can be difficult when the missing data results from different underlying mechanisms which interact in complex ways and may significantly affect the observable data and vice-versa.

Advantageously, the described techniques enable the generation of high-quality and privacy-protecting synthetic data from real datasets while preserving observable data, as well as missing data distribution, and allow a tradeoff between computational efficiency and quality.

Advantageously, the described techniques produce high-quality synthetic data by reducing the wastage of data. The reduction of data wastage is important since data is a precious resource and expensive asset. Synthetic datasets that preserve missing value distribution make it possible to leverage domain and problem-specific methodologies and expertise in dealing with missing values in optimization and learning and analysis, which have been shown to improve the quality of results, instead of the convention method of fitting one solution to all problems (e.g., deleting samples with missing values).

Synthetic data has numerous applications both commercially and scientifically. For example, for data privacy-related regulatory compliance, one can use, share, and analyze synthetic data in place of real data. Synthetic data provides an effective method to deal with data shortage for learning, as it can be used to augment the data for training and improve the models. In addition, emerging start-up businesses that provide synthetic data or mechanisms to generate synthetic data can improve their products and data using our algorithmic models and reduce their data wastage.

Synthetic data enables the aggregation of sensitive data from multiple sites, organizations, and corporations (their partners and subsidiaries), states, and even countries while being in data privacy related regulatory compliance. This is important for the healthcare and bioinformatics areas and applications and research.

One application domain is in healthcare. Healthcare data typically always has missing values; additionally, it is highly sensitive, and its use and sharing are governed by various laws and regulations. Synthetic data makes valuable healthcare and bioinformatics data accessible from segregated and un-combinable locked data silos. A company can use synthetic data in place of sensitive real data while using outside services to improve in-house processes and models. For example, synthetic data can be shared with a third-party consulting firm while acquiring their services.

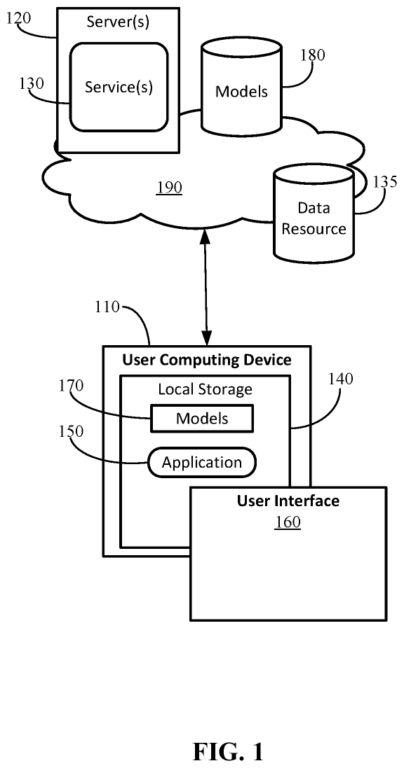

FIG. 1 illustrates an example operating environment in which various embodiments of the invention may be practiced. Referring to FIG. 1, an example operating environment can include a user computing device 110, a server 120 implementing synthetic data services 130, and a data resource 135 comprising one or more databases configured to store datasets.

User computing device (e.g., user computing device 110) may be a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen.

User computing device (e.g., user computing device 110) includes, among other components, a local storage 140 on which an application 150 may be stored. The application 150 may be an application with a synthetic data tool or may be a web browser or front-end application that accesses the application with the synthetic data tool over the Internet or other network. In some cases, application 150 includes a graphical user interface 160 that can be configured to display sets of data, including real data and/or synthetic data. Application 150 may be any suitable application, such as, but is not limited to a productivity application, a data generation application, a data collection application, a data analysis application, or a database management application. Although reference is made to an “application”, it should be understood that the application, such as application 150 can have varying scope of functionality. That is, the application can be a stand-alone application or an add-in or feature of a stand-alone application.

The example operating environment can support an offline implementation, as well as an online implementation. In the offline scenario, a user may directly or indirectly (e.g., by being in a synthetic data mode or by issuing a command to generate synthetic data) select a set of data or one or more missing patterns displayed in the user interface 160. The synthetic data generator (e.g., as part of application 150) can use a set of models 170 stored in the local storage 140 to generate synthetic data. The models 170 may be provided as part of the synthetic data tool and, depending on the robustness of the computing device 110 may be a ‘lighter’ version (e.g., may have fewer feature sets) than models available at a server.

In the online scenario, a user may directly or indirectly select a set of data displayed in the user interface 160. The synthetic data tool (e.g., as part of application 150) can communicate with the server 120 providing synthetic data services 130 that use one or more models 180 to generate synthetic data.

Components (computing systems, storage resources, and the like) in the operating environment may operate on or in communication with each other over a network 190. The network 190 can be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The network 190 may include one or more connected networks (e.g., a multi-network environment) including public networks, such as the Internet, and/or private networks such as a secure enterprise private network. Access to the network 190 may be provided via one or more wired or wireless access networks as will be understood by those skilled in the art.

As will also be appreciated by those skilled in the art, communication networks can take several different forms and can use several different communication protocols. Certain embodiments of the invention can be practiced in distributed-computing environments where tasks are performed by remote-processing devices that are linked through a network. In a distributed-computing environment, program modules can be located in both local and remote computer-readable storage media.

Communication to and from the components may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

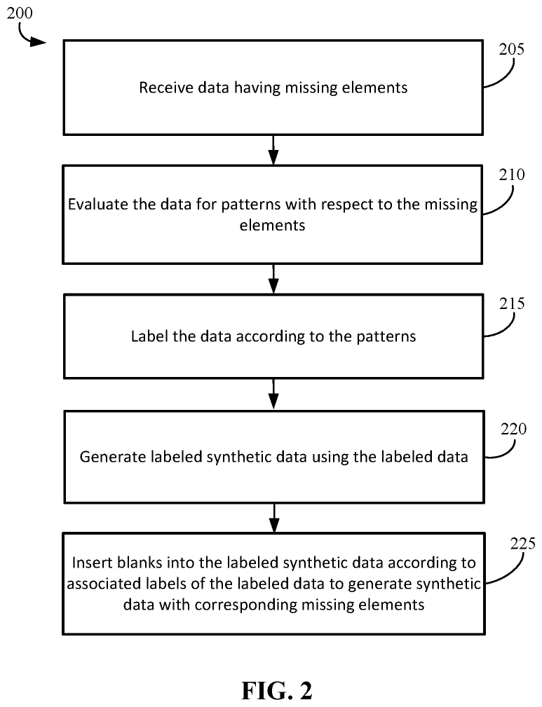

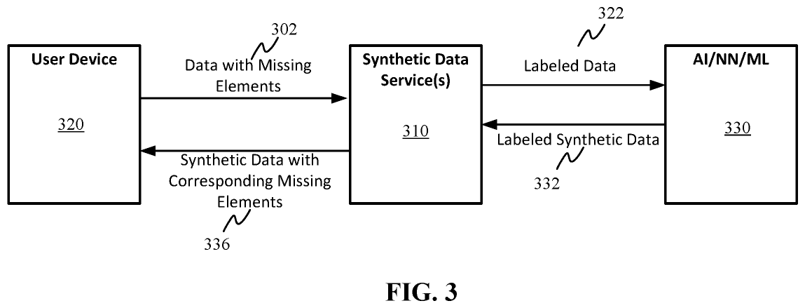

FIG. 2 illustrates example processes for generating synthetic data according to certain embodiments of the invention. Referring to FIG. 2, some or all of process 200 may be executed at, for example, server 120 as part of services 130 (e.g., server 120 may include instructions to perform process 200). In some cases, process 200 may be executed entirely at computing device 110, for example, as an offline version (e.g., computing device 110 may include instructions to perform process 200). In some cases, process 200 may be executed at computing device 110 while in communication with server 120 to support the generation of synthetic data (as discussed in more detail with respect to FIG. 3).

Process 200 can include receiving (205) data having missing elements. The data may be received through a variety of channels and in a number of ways. In some cases, a user may upload the data through a submission portal or other interface. In some cases, the data is retrieved from a database (e.g., data resource 135 as described in FIG. 1).

The data can be real data or synthetic data. In some cases, the real data can include sensitive personal information. The data can be any structured data, such as tabular data, lists, textual data, or temporal data. Tabular data refers to data that is organized in a table with rows and columns. The tabular data can be either numeric data or categorical data. It should be noted that while the data is described as structured data, the data may be any type of data, such as semi-structured data or unstructured data.

The data can include a set of samples. A sample refers to an individual set of data, such as a record. Each sample has one or more elements, such as an observed (non-missing) element or a missing element. A missing element can include, for example, a missing value, or a non-number value.

Process 200 further includes evaluating (210) the data for patterns with respect to the missing elements. The patterns can be a missing pattern, which is used to characterize missing values, or missingness, in the data. The pattern can describe which values are observed and which values are missing in the data. The data can be evaluated using any suitable pattern recognition method, such as K-means clustering, EM-clustering, and hierarchical clustering.

In some cases, a visualization of the determined patterns can be provided to the user. In this case, the user can then select one or more of the patterns to be used for generating the synthetic data.

Process 200 further includes labeling (215) the data according to the patterns; and generating (220) labeled synthetic data using the labeled data. The labeled synthetic data can be generated using any data generator model (DGM) such as a suitable neural network, machine learning, or other artificial intelligence process. Examples include, but are not limited to, hierarchical and non-hierarchical Bayesian methods; supervised learning methods such as mixture of Gaussian models, neural nets, bagged/boosted or randomized decision trees, and nearest neighbor based approaches; and unsupervised methods such as k-means clustering and agglomerative clustering.

For example, a Bayesian network can be used as the DGM to generate the labeled synthetic data. Illustrative examples include a missingness encoding data generator based on a Bayesian network (MergeBN) and a Hott-partitioning Data Generator based on a Bayesian network (HottBN).

In some cases, a variation auto-encoder can be used as the DGM to generate the labeled synthetic data. Examples of such implementations include a missingness encoding data generator based on a variation auto-encoder (MergeVAE) and a Hott-partitioning Data Generator based on a variation auto-encoder (HottVAE).

In some cases, a generative adversarial network (GAN) can be used as the DGM to generate the labeled synthetic data. Examples of GAN-based implementations of the DGM include a missingness encoding data generator based on a GAN (MergeGAN), a Hott-partitioning Data Generator based on a GAN (HottGAN), and HottGAN+(a hybrid of MergeGAN and HottGAN). In this case, the GAN can be trained using the labeled data.

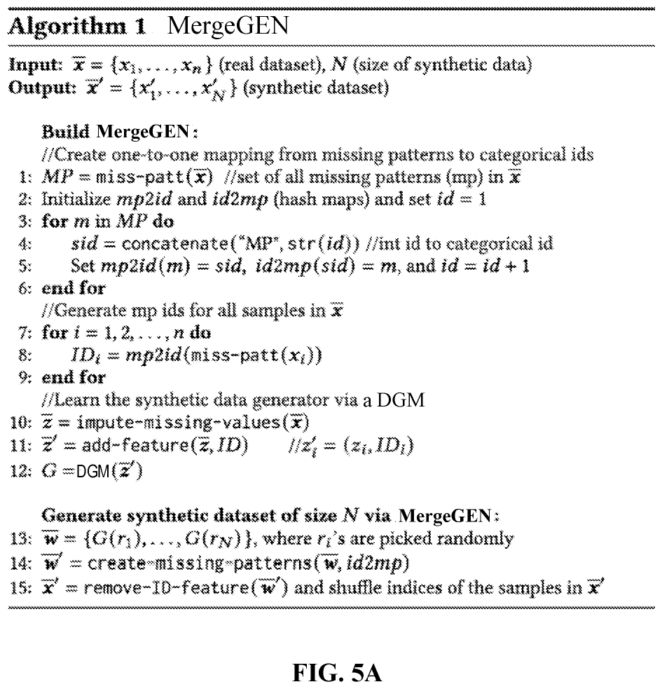

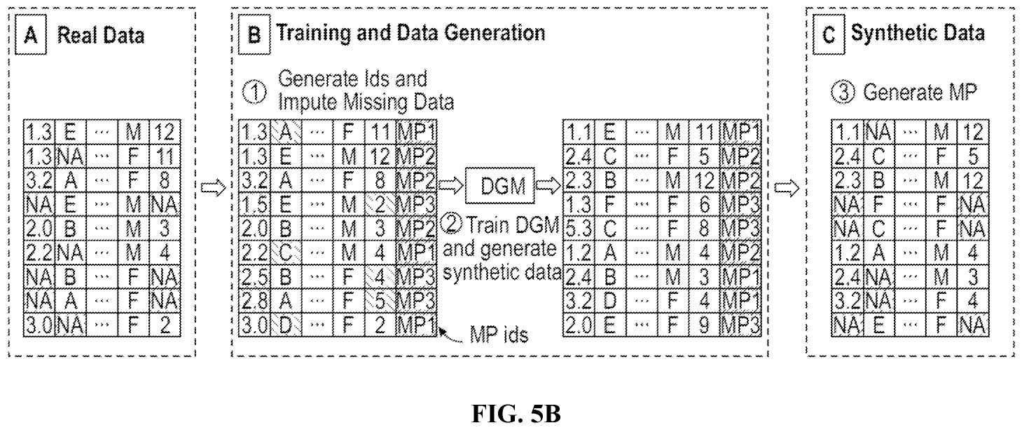

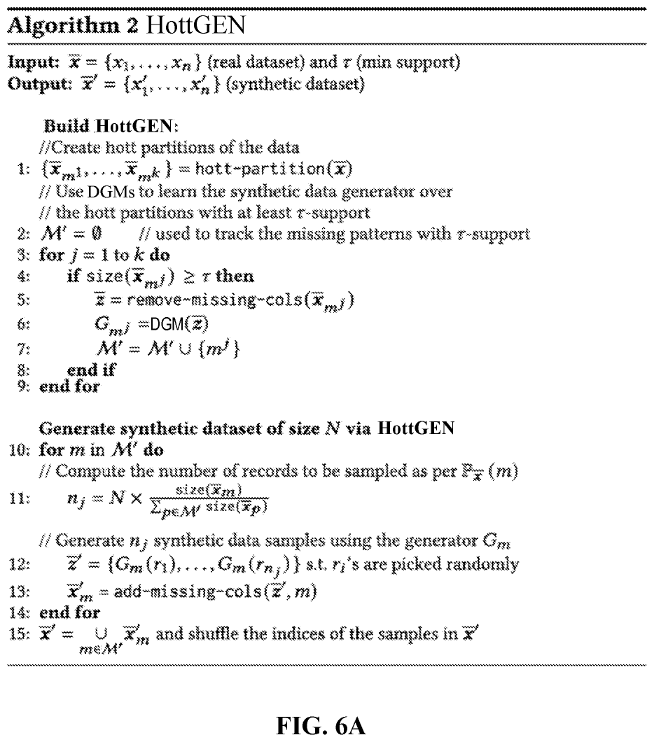

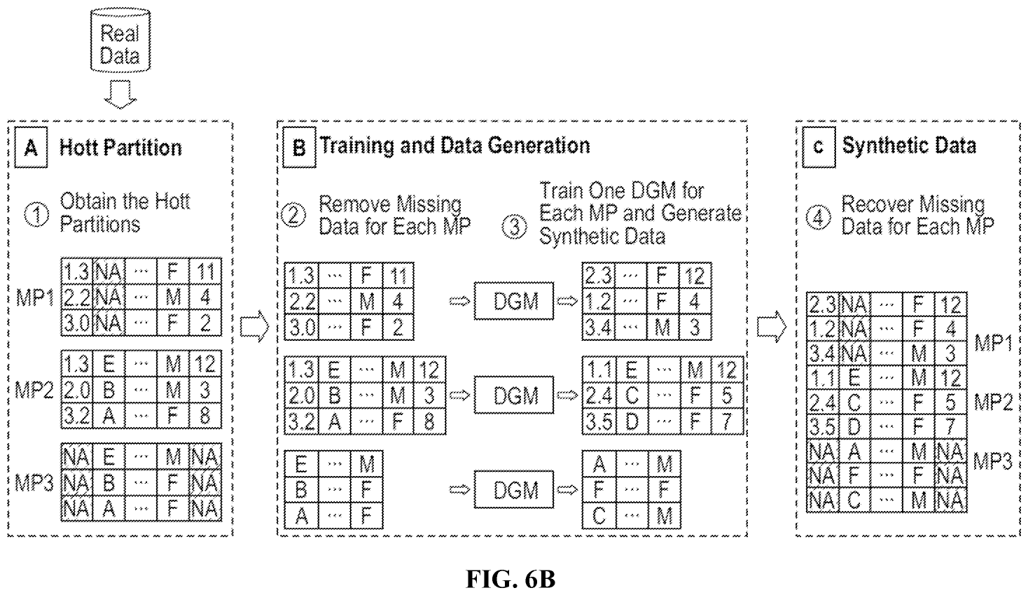

General algorithms for a missingness encoding data generator using a DGM (MergeGEN) and a Hott-partitioning Data Generator using a DGM (HottGEN) are described and shown in FIGS. 5A-5B and FIGS. 6A-6B, respectively. When MergeGEN uses a specific DGM such as a GAN, the instantiated method is referred to as MergeGAN. As an illustrative example of MergeGAN, labeling the data according to the patterns comprises applying a label indicating a pattern to each sample in the set of samples independently. In this case, values for the missing elements of data can be imputed before generating the labeled synthetic data. The values for the missing elements can be imputed using any suitable method for imputation. The MergeGAN can be trained using the labeled data and the labeled synthetic data can be generated using MergeGAN.

When HottGEN uses a specific DGM such as a GAN, the instantiated method is referred to as HottGAN. As an illustrative example of HottGAN, the samples of the set of samples are grouped into partitions before labeling the data according to the patterns, where each group includes samples with identical patterns with respect to the missing elements. In this case, a label indicating a pattern with respect to the missing elements is applied to each group. generating labeled synthetic data using the labeled data comprises generating separate sets of labeled synthetic data corresponding to each labeled group. The HottGAN can be trained using the labeled data and the labeled synthetic data can be generated using HottGAN.

As yet another illustrative example, the labeled synthetic data can be generated using a hybrid method, such as HottGAN+. In this illustrative example, HottGAN can be trained over one or more top k-pattems (e.g., the k hot partitions with the most support). The HottGAN can be used to generate corresponding synthetic data. Typically, the remaining patterns and corresponding labeled data would be discarded. However, with HottGAN+, MergeGAN can be used to generate additional synthetic data for any remaining patterns. Other HottGEN+ instantiations such as HottVAE+ and HottBN+ can be similarly implemented following the same methodology.

Advantageously, the synthetic data protects privacy as it is generated by a model and not directly collected from any individual. As opposed to conventional methods, the described technique of generating synthetic data is “missing data friendly,” a quality often missing from synthetic data modelers. The described synthetic data modeler models both the observable data distribution and missing data distribution: this is either done as conditional distributions or as a joint distribution. For certain missing data settings (i.e., the underlying procedure or phenomena causing missingness in the data), the modeler takes a hybrid approach, i.e., a mix of join and conditional distributions. Once these distributions are learned, they are used to generate synthetic data.

Process 200 further includes inserting (225) blanks into the labeled synthetic data according to associated labels of the labeled data to generate synthetic data with corresponding missing elements.

Advantageously, inserting the blanks into the labeled synthetic data preserves the observable data as well as missing data distribution in the synthetically generated data. Indeed, the generated synthetic data with corresponding missing elements mimics the real data (the data received at step 205) in terms of both missing pattern distribution as well as non-missing data distribution.

FIG. 3 illustrates an example implementation of generating synthetic data. Referring to FIG. 3, data having missing elements 302 can be received at synthetic data service(s) 310. The data 302 can be received through a variety of channels and in a number of ways. In some cases, a user may upload the data through a submission portal or other interface on a computing device 320 such as described with respect to computing device 110 and user interface 160 of FIG. 1. In some cases, the data is retrieved from a database (e.g., data resource 135 as described in FIG. 1).

Aspects of synthetic data service(s) 310 may themselves be carried out on computing device 320 and/or may be performed at a server such as server 120 described with respect to FIG. 1.

The synthetic data service(s) 310 can evaluate the data 302 for patterns with respect to the missing elements and label the data according to the patterns. The pattern can describe which values are observed and which values are missing in the data. The data 302 can be evaluated using any suitable pattern recognition method, such as K-means clustering, EM-clustering, and hierarchical clustering.

The labeled data 322 may be communicated to a synthetic data engine 330, which may be a neural network or other machine learning or artificial intelligence engine, for generating synthetic data. The synthetic data engine 330 generates labeled synthetic data 332. The synthetic data engine 330 can generate labeled synthetic data as described with respect to operation 220 of FIG. 2.

The labeled synthetic data 332 generated by the synthetic data engine 330 can be returned to the synthetic data service(s) 310, which can generate synthetic data with corresponding missing elements 336. The synthetic data service(s) 310 can generate synthetic data with corresponding missing elements 336 by inserting blanks into the labeled synthetic data 332 according to associated labels of the labeled data 322. The synthetic data service(s) 310 can provide the synthetic data with corresponding missing elements 336 to the computing device 320 for display.

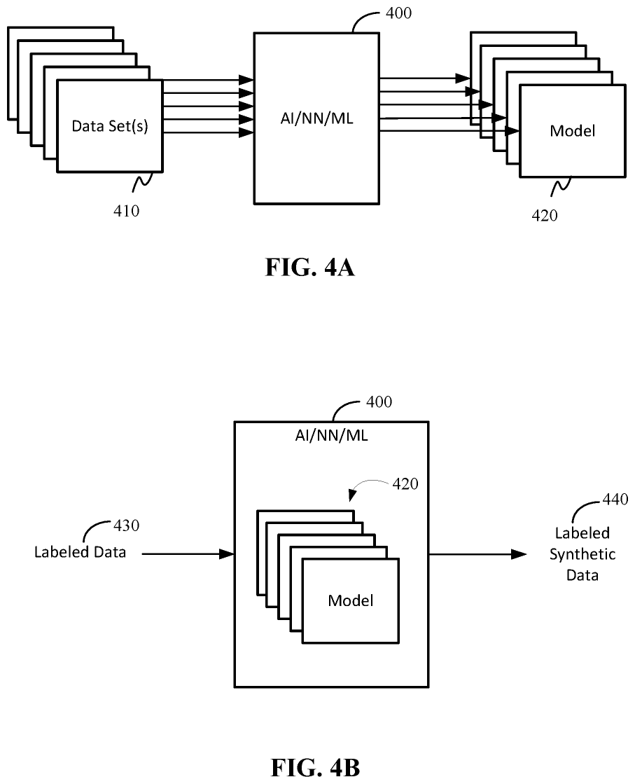

FIGS. 4A and 4B illustrate an example synthetic data engine, where FIG. 4A shows a process flow for generating models and FIG. 4B shows a process flow for operation. Turning first to FIG. 4A, a synthetic data engine 400 may be trained on various sets of data 410 to generate appropriate data generator models 420.

The synthetic data engine 400 may continuously receive additional sets of data 410, which may be processed to update the data generator models 420. As previously described, in some cases, the data generator models 420 can be stored locally, for example, as an offline version. In some of such cases, the data generator models 420 may continue to be updated locally.

The data generator models 420 may include models generated using any suitable neural network, machine learning, or other artificial intelligence process. It should be understood that the methods of generating synthetic data include, but are not limited to, generative adversarial network (GAN) based methods (e.g., MergeGAN and HottGAN), hierarchical and non-hierarchical Bayesian methods (e.g., MergeBN and HottBN); supervised learning methods such as neural nets, mixture of Gaussian models, bagged/boosted or randomized decision trees, and nearest neighbor approaches; and unsupervised methods such as k-means clustering and agglomerative clustering (as well as autoencoder-based methods such as MergeVAE and HottVAE).

Turning to FIG. 4B, the models may be mapped to particular patterns such that when data labeled with one of the particular patterns (labeled data 430) is provided to the synthetic data engine 400, the appropriate data generator model(s) 420 can be selected to produce labeled synthetic data 440.

FIG. 5A illustrates details of a general MergeGEN algorithm used to generate synthetic data according to certain embodiments of the invention; and FIG. 5B illustrates a pictorial overview of the MergeGEN algorithm described in FIG. 5A.

MergeGEN aims to learn [symbol] (X₀, M), i.e., it learns the data distribution without missing values together with the mp-distribution. Referring to FIG. 5A, Algorithm 1 provides the details for MergeGEN. MergeGEN begins by creating categorical ids for each missing pattern in the given dataset (x̅), which are referred to these ids as missing pattern ids or MP ids. The categorical data type for the MP ids can be used instead of integers (or ordinals) to prevent the data generator model from making use of their geometric or other numeric properties. Using the MP ids, maps (i.e., hash maps) can be created to map the MP ids to missing pattern and vice versa, as shown in lines 1-6 of Algorithm 1. The (pattern-to-id) mapping can be used to generate MP ids (IDᵢ) for each sample xᵢ in x̅, as shown in lines 7-9 of Algorithm 1. Since the data generator model cannot learn the generator using the missing values, all the missing values in z, are imputed and the MP ids are added as an additional feature to the imputed z to obtain the processed dataset z̅′ as shown in lines 10-11 of Algorithm 1. Any data generator model (e.g., GAN) can then be used to learn the synthetic data generator, G, over the processed dataset, as shown in line 12 of Algorithm 1.

To generate synthetic data (of size e.g., N=n), the generator can be used to produce N samples, as shown in line 13 of Algorithm 1, and create missing patterns as per the MP id in each of the generated sample, as shown in line 14 of Algorithm 1. The MP id feature (i.e., ID) is removed to produce the synthetic dataset with missing values, as shown in line 15 of Algorithm 1.

Referring to FIG. 5B, the grey boxes in “A Real data” and “C Synthetic data” denote missing values. The white boxes in “A Real data” “B Training and data generation”, and “C Synthetic data” denote non-missing values. The light grey boxes in “B Training and data generation” denote imputed values and the dark grey boxes (containing “MP1”, “MP2”, or “MP3”) in “B Training and data generation” denote missing pattern (MP) ids.

FIG. 6A illustrates details of a general HottGEN algorithm used to generate synthetic data according to certain embodiments of the invention; and FIG. 6B illustrates a pictorial overview of the HottGEN algorithm described in FIG. 6A.

HottGEN consists of a collection of generators, each learned via a data generator model (such as GAN) over different set of samples from dataset x̅. These set of samples are called the hott partition. The hott partition of x̅ divides the samples in x̅ into different sets (x̅ₘ for each missing pattern m in x̅) such that all the samples in each set (i.e., x̅ₘ) only consist of the samples with the same missing pattern (m).

Definition 3.2 (Hott partition). For any given dataset x̅={x̅₁, . . . , xₙ}, let [symbol] ={m¹, . . . , m^{k}}=miss-patt(x̅) be the set of missing patterns in x̅. Then, x̅ₘ_{¹}, . . . , x̅ₘ_{^{k}} makes the homogeneous pattern (Hott) partition of x if

$$x = {⋃}_{m ∈ ℳ} {\overline{x}}_{m}$$

and each x̅ₘ_{^{j}} contains the samples with missing pattern m^{j}.

Referring to FIG. 6A, Algorithm 2 gives the details of HottGEN, the method of generating synthetic data using hott partitioning. HottGEN begins by first obtaining the hott partition of x, as shown in line 1 of Algorithm 2. Since all the samples in x̅ₘ (i.e., each hott partition) has the same missing pattern, (without affecting the observable data) all columns with missing values are removed, as shown in line 5 of Algorithm 2. Moreover, only the partitions that have a minimum support T are considered, as shown in line 4 of Algorithm 2: this ensures that there is sufficient data to train the data generator model (such as GAN), as shown in line 6 of Algorithm 2.

Once the generators are learned, the generators are used to generate synthetic dataset of size N, as shown in lines 10-15 of Algorithm 2, where it is assumed N= [symbol] |x̅ₚ| to keep the correspondence with the latter analysis. For each pattern m^{j} with at least τ-support (i.e., |x̅ₘ|≥τ), the proportionally appropriate number, nⱼ, of samples with missing pattern m^{j} (as shown in line 11 of Algorithm 2, size(x̅ₘ_{^{j}})=size|x̅ₘ_{^{j}}|) is calculated. This is followed by generating nⱼ samples using the generator Gₘ_{^{j}}, as shown in line 12 of Algorithm 2, adding the missing columns, and combining all the samples together, as shown in lines 12-15 of Algorithm 2, to produce the synthetic dataset.

Referring to FIG. 6B, the grey boxes denote missing values.

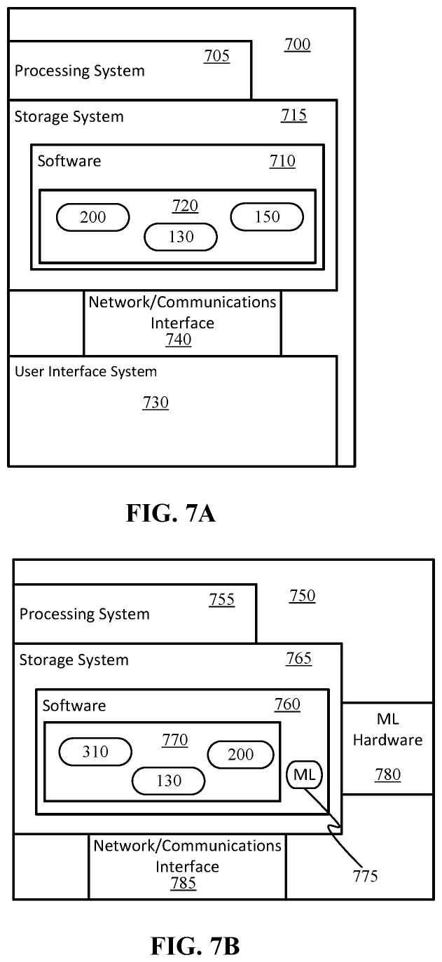

FIGS. 7A and 7B illustrate components of example computing systems that may carry out the described processes. Referring to FIG. 7A, system 700 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen. Accordingly, more or fewer elements described with respect to system 700 may be incorporated to implement a particular computing device. Referring to FIG. 7B, system 750 may be implemented within a single computing device or distributed across multiple computing devices or sub-systems that cooperate in executing program instructions. Accordingly, more or fewer elements described with respect to system 750 may be incorporated to implement a particular system. The system 750 can include one or more blade server devices, standalone server devices, personal computers, routers, hubs, switches, bridges, firewall devices, intrusion detection devices, mainframe computers, network-attached storage devices, and other types of computing devices.

In embodiments where the system 750 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

Systems 700 and 750 can include processing systems 705, 755 of one or more processors to transform or manipulate data according to the instructions of software 710, 760 stored on a storage system 715, 765. Examples of processors of the processing systems 705, 755 include general purpose central processing units (CPUs), graphics processing units (GPUs), field programmable gate arrays (FPGAs), application specific processors, and logic devices, as well as any other type of processing device, combinations, or variations thereof.

The software 710 can include an operating system and application programs 720, including application 150 and/or services 130, as described with respect to FIG. 1 (and in some cases aspects of service(s) 310 such as described with respect to FIG. 3). In some cases, application 720 can perform some or all of process 200 as described with respect to FIG. 2.

Software 760 can include an operating system and application programs 770, including services 130 as described with respect to FIG. 1 and services 310 such as described with respect to FIG. 3; and application 770 may perform some or all of process 200 as described with respect to FIG. 2. In some cases, software 760 includes instructions 775 supporting machine learning or other implementation of a synthetic data engine such as described with respect to FIGS. 3, 4A and 4B. In some cases, system 750 can include or communicate with machine learning hardware 780 to instantiate a synthetic data engine.

In some cases, models (e.g., models 170, 180, 420) may be stored in storage system 715, 765.

Storage systems 715, 765 may comprise any suitable computer readable storage media. Storage system 715, 765 may include volatile and nonvolatile memories, removable and non-removable media implemented in any method or technology for storage of information, such as computer readable instructions, data structures, program modules, or other data. Examples of storage media of storage system 715, 765 include random access memory, read only memory, magnetic disks, optical disks, CDs, DVDs, flash memory, magnetic cassettes, magnetic tape, magnetic disk storage or other magnetic storage devices, or any other suitable storage media. In no case do storage media consist of transitory, propagating signals.

Storage system 715, 765 may be implemented as a single storage device but may also be implemented across multiple storage devices or sub-systems co-located or distributed relative to each other. Storage system 715, 765 may include additional elements, such as a controller, capable of communicating with processing system 705, 755.

System 700 can further include user interface system 730, which may include input/output (I/O) devices and components that enable communication between a user and the system 700. User interface system 730 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 730 may also include output devices such as display screen(s), speakers, haptic devices for tactile feedback, and other types of output devices. In certain cases, the input and output devices may be combined in a single device, such as a touchscreen display which both depicts images and receives touch gesture input from the user.

A natural user interface (NUI) may be included as part of the user interface system 730 for a user to input selections, commands, and other requests, as well as to input content. Examples of NUI methods include those relying on speech recognition, touch and stylus recognition, gesture recognition both on screen and adjacent to the screen, air gestures, head and eye tracking, voice and speech, vision, touch, hover, gestures, and machine intelligence.

Visual output may be depicted on a display in myriad ways, presenting graphical user interface elements, text, images, video, notifications, virtual buttons, virtual keyboards, or any other type of information capable of being depicted in visual form.

The user interface system 730 may also include user interface software and associated software (e.g., for graphics chips and input devices) executed by the OS in support of the various user input and output devices. The associated software assists the OS in communicating user interface hardware events to application programs using defined mechanisms. The user interface system 730 including user interface software may support a graphical user interface, a natural user interface, or any other type of user interface.

Network interface 740, 785 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain Embodiments may be implemented as a computer process, a computing system, or as an article of manufacture, such as a computer program product or computer-readable storage medium. Certain methods and processes described herein can be embodied as software, code and/or data, which may be stored on one or more storage media. Certain embodiments of the invention contemplate the use of a machine in the form of a computer system within which a set of instructions, when executed by hardware of the computer system (e.g., a processor or processing system), can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals.

### Theoretical Support

To provide theoretical support of the described techniques, the inventors formalized the problem of preserving observable and missing data distribution in synthetic data generation; and defined a novel similarity measure over two datasets with missing values that takes into account both observable and missing data distribution. In particular, the inventors used this to quantify the quality of the synthetic data.

A notion of (α, β)-closeness is defined that incorporates two distinct elements: the L₁ distances, denoted as Dₘᵢₛ, which measures the divergence between the mp-distributions of the synthetic and real datasets, and a similarity measure, S, to measure how statistically close the two datasets are. A synthetic dataset can be considered (α, β)-close to a given dataset if the divergence between their mp-distributions is upper bounded by a and (dis)similarity is upper bounded by β.

The divergence in mp-distribution, i.e., Dₘᵢₛ, is defined as follows.

For any given datasets x̅ and x̅′,

$${δ}_{m} ( \overline{x} , {\overline{x}}^{′} ) = \vert {ℙ}_{\overline{x}} ( m ) - {ℙ}_{{\overline{x}}^{′}} ( m ) \vert , and$$

$${D}_{m i s} ( \overline{x} , {\overline{x}}^{′} ) = {‖ {ℙ}_{\overline{x}} ( M ) - {ℙ}_{{\overline{x}}^{′}} ( M ) ‖}_{1} = {\sum }_{m ∈ ℳ𝒫} {δ}_{m} ( \overline{x} , {\overline{x}}^{′} ) .$$

Since S is meant to capture how similar x̅′ is to x̅, a metric over the space of datasets can be used to define S. However, due to varying missing patterns across samples and unequal sizes of the datasets the existing metrics do not apply directly. For example, two samples with different missing pattern can have different dimensions (in terms of observable features), and thus, cannot be compared as such—e.g., think of comparing (1, NA, 5) to (NA, 9, NA). Accordingly, a similarity scoring function, s, is used to measure the similarity between samples with the same missing pattern m

$$( i . e . {\overline{x}}_{m} , {\overline{x}}_{m}^{′} )$$

from the two datasets (x̅ and x̅′); and then, S(x̅, x̅′) is defined as a weighted average of these scores. Thus, for a given similarity function s and non-negative weights, γ, the similarity can be defined as:

$$S ( \overline{x} , {\overline{x}}^{′} ) = \sqrt{{\sum }_{m ∈ ℳ𝒫} {γ}_{m} \cdot {s}^{2} ( {\overline{x}}_{m} , {\overline{x}}_{m}^{′} )}$$

where γₘ gives the weights corresponding to the missing pattern m. The similarity between x̅m and

$${\overline{x}}_{m}^{′}$$

is defined as an average Wasserstein distance, [symbol] , i.e.,

$$s ( {\overline{x}}_{m} , {\overline{x}}_{m}^{′} ) = 𝒲 ( {\overline{x}}_{m} , {\overline{x}}_{m}^{′} ) .$$

Further, the weights γ are defined with respect to a reference dataset [symbol] such that for every m∈ [symbol] we have γₘ= [symbol] (m)+δₘ(x̅, x̅′); thus, giving:

$${S}_{\overline{z}} ( \overline{x} , {x}^{′} ) = \sqrt{{\sum }_{m ∈ ℳ𝒫} ( {ℙ}_{\overline{𝓏}} ( m ) + {δ}_{m} ( \overline{x} , {\overline{x}}^{′} ) ) \cdot {𝒲}^{2} ( {\overline{x}}_{m} , {\overline{x}}_{m}^{′} )}$$

Above, [symbol] is used as the subscript to denote the use of the specific weight function. Note that since the relation gives average distance, the smaller the value of [symbol] , the higher the similarity. Thus, (α, β)-closeness can be defined as follows:

For given α, β≥0 and a dataset x, a dataset x̅′ is (α, β)-close to x̅ if

$${D}_{m i s} ( \overline{x} , {\overline{x}}^{′} ) \leq α and {S}_{\overline{x}} ( \overline{x} , {\overline{x}}^{′} ) \leq β$$

Note that the reference dataset (above) is fixed as the given dataset, i.e., [symbol] =x̅. Thus, giving

$${γ}_{m} ( {\overline{x}}_{m} , {\overline{x}}_{m}^{′} ) = {ℙ}_{\overline{x}} ( m ) + {δ}_{m} ( \overline{x} , {\overline{x}}^{′} ) .$$

The [symbol] (m) term weights the distance between x̅ₘ and

$${\overline{x}}_{m}^{′}$$

proportional to the size of x̅ₘ so that the missing pattern that covers more samples has more weight than the pattern that covers fewer samples of the dataset. The om term accounts for the dissimilarity based on the divergence in the mp-distribution. Consider γ but without the δₘ term, i.e., γₘ= [symbol] (m); and let the S corresponding to these weights be denoted as [symbol] . Now, compare ST with S_{x̅} with [symbol] to see how (α, β)-closeness—that is, Dₘᵢₛ and S_{x̅}together—capture the desired properties for the problem setting. For instance, when the divergence in mp-distributions of x̅ and x̅′ is zero, i.e., Dₘᵢₛ(x̅, x̅′)=0, S_{x̅}(x̅, x̅′)= [symbol] (x̅, x̅′). And when Dₘᵢₛ(x̅, x̅′)>0, it follows that S_{x̅}(x̅, x̅′)> [symbol] (x̅, x̅′). That is, the two synthetic datasets that have same similarity score for each missing pattern (with respect to x̅), but differ in their mp-distributions (from that of x̅), the one with higher Dₘᵢₛ will be deemed more dissimilar from x̅ than the other.

Now consider the case of two datasets that may contain one or more (and possibly different) missing patterns. For a missing pattern m, let x̅ₘ and

$${\overline{x}}_{m}^{′}$$

be the sets of samples from x̅ and x̅′ (respectively) that have the same missing pattern m.

For given two datasets, x̅ₘ of size N and x̅′ₘ of size N′, which have the same missing pattern m, the average Wasserstein distance is defined as follows:

$${𝒲}^{2} ( {\overline{x}}_{m} , {\overline{x}}_{m}^{′} ) = \{ \begin{matrix}0 & N = {N}^{′} = 0 \\ {W}^{2} ( {\overline{x}}_{m} , {\overline{x}}_{m}^{′} ) & N = {N}^{′} > 0 \\ {( \begin{matrix}N \\ {N}^{′}\end{matrix} )}^{- 1} {\sum }_{𝓏 ∈ {C}_{\overline{x} , {N}^{′}}} {W}^{2} ( \overline{z} , {\overline{x}}_{m}^{′} ) & N > {N}^{′} > 0 \\ {𝒲}^{2} ( {\overline{x}}_{m}^{′} , {\overline{x}}_{m} ) & {N}^{′} > N > 0 \\ {𝒲}^{2} ( {\overline{x}}_{m} , \{ {0}_{m} \} ) & {N}^{′} = 0 \\ {𝒲}^{2} ( {\overline{x}}_{m}^{′} , {\overline{x}}_{m} ) & N = 0\end{matrix}$$

where 0ₘ is a sample with missing pattern and all non-missing values as zero; and

$${C}_{\overline{x} , {N}^{′}}$$

is the set of all datasets of size N′ that can be made from samples in x̅ₘ, that is, if x̅ₘ={x₁, . . . , x_{N}}, then

$${C}_{\overline{x} , {N}^{′}} = \{ {x}_{i} in {\overline{x}}_{m} \vert i ∈ I$$

and I⊆[N], s.t. |I|=N′, and hence, its size is

$$( \begin{matrix}N \\ {N}^{′}\end{matrix} ) .$$

As provided in more detail below, a synthetic dataset can be generated that mimics real data in terms of both missing pattern distribution as well as non-missing data distribution.

The inventors proposed a suite of methods using different data generator models (such as GAN, Bayesian Network, and Variational Auto-encoder) that can generate high quality synthetic data that can preserve missing data distribution, and allow a tradeoff between computational efficiency and quality; and analyzed the performance of the proposed methods under the MCAR. MAR, and MNAR settings, which captured a variety of realistic situations under which data is missing.

An extensive empirical evaluation over a range of fabricated and real-world datasets shows that the proposed methods work under different missing data settings. Detailed results are provided in FIGS. 8A-8D, 9, 10A, 10B, 1A-11E, 12, and 13.

Three fabricated datasets were created: Gauss 1, Gauss 2, and Gauss 3.

The Gauss 1 dataset consists of 3 features and 10000 records (i.e., samples), with two correlated and one independent feature. The missing mechanism depends on the value of feature 1, which for a given quantile value q: replaces the value of feature 2 by NA (probabilistically by flipping a coin) if feature 1's value is below 1-th quantile, where q=0.2, 0.4, 0.6, 0.8 is used to obtain 5 different datasets.

The Gauss 2 dataset has more missing patterns (MPs) and a complex mp-distribution as compared to the Gauss 1. Each Gauss 2 dataset consists of 6 features and 25000 records, where except for one feature, all others are correlated for different coefficient values. The missing values are created in 4 of its 6 features, each with a different specification (i.e., quantile value) of the missing mechanism, which probabilistically depends on two features (i.e., feature 1 or feature 2 depending upon a fair coin flip). The quantiles 0.2, 0.4, 0.6, and 0.8 respectively correspond to features 3, 4, 5, and 6.

The Gauss 3 dataset was sampled from a multivariate Gaussian distribution with missing values created by different MCAR, MAR, and MNAR mechanisms. Gauss 3 consists of 6 features and 21 missing patterns. The largest missing pattern covers 36.7% of the total samples (i.e., 17977 samples) while the smallest one covers 0.4%, i.e., 214 samples.

The quality of the datasets created via various methods, including Deletion, Imputation, MisGAN (Steven Cheng-Xian Li, Bo Jiang, and Benjamin Marlin. 2019. Misgan: Learning from incomplete data with generative adversarial networks. arXiv preprint arXiv:1902.09599 (2019)), Bayesian Network (BN) (Daphne Koller and Nir Friedman. 2009. Probabilistic graphical models: principles and techniques. MIT press), fRand, pRand, MergeGAN (MergeGEN using GAN), MergeVAE (MergeGEN using variation auto-encoder), MergeBN (MergeGEN using Bayesian network), HottGAN (HottGEN using GAN), HottVAE (HottGEN using variation auto-encoder), and HottBN (HottGEN using Bayesian network), were measured using tests including relative error of mean (REM) and standard deviation (RESD) of real and synthetic datasets, χ²-test (for each discrete feature), Pearson correlation distance, t-Distributed Stochastic Neighbor Embedding (t-SNE) analysis, (α, β)-closeness (i.e., the mp-distribution divergence (Dₘᵢₛ), and the similarity (via weighed average Wasserstein distance) between the given and generated datasets). MergeGAN, MergeVAE, and MergeBN were implemented by using GAN, VAE, and BN respectively as the data generator model in MergeGEN. HottGAN, HottVAE, and HottBN were implemented by using GAN, VAE, and BN, respectively, as the data generator model in HottGEN. fRand and pRand methods involved the following.

To learn a generator, Gₘ_{^{*}}, via GAN, a set of complete samples, x̅_{m*}, are used from the given dataset, x̅={x₁, . . . , xₙ}. Namely, x̅ₘ_{^{*}} consists of the samples that have no missing values, i.e., each sample in x̅ₘ_{^{*}} has the missing pattern m*=0. Thus, Gₘ_{^{*}}←GAN(x̅ₘ_{^{*}}).

To learn the mp-distribution, the proportion of each missing pattern in x̅, i.e., [symbol] (m)=|x̅ₘ|/|x̅| is calculated for every missing pattern m. Indeed, for any m that is not present in x̅, [symbol] (m)=0.

Now, to generate a synthetic dataset x̅′ of size N=n, the following is performed: begin with x̅′={ }. Then, for every m such that [symbol] (m)>0, generate Nₘ=N· [symbol] (m) samples from Gₘ_{^{*}}, i.e.

$${x}_{1}^{′} ← {G}_{{m}^{*}} ( {r}_{1} ) , … , {x}_{{N}_{m}}^{′} ← {G}_{{m}^{*}} ( {r}_{{N}_{m}} )$$

where r j's are picked randomly, and in each sample

$${x}_{j}^{′} ,$$

missing values are created as per the missing pattern m, and all these generated samples with missing values are added to x̅′. This method is referred to as pRand.

An alternative way to create missing patterns in the generated sample is to create missing values independently in each feature based on the feature's missing rate, i.e., [symbol] (Mⱼ=1). Note that the random variable for the missing pattern is M=(M₁, . . . , Mⱼ, . . . , M_{d}), where Mⱼ is the random variable corresponding to the j-th feature. The missing rate for j-th feature for the given x̅ is denoted as [symbol] (mⱼ=1) and can be estimated for each j as: [symbol] _{x̅}(mⱼ=1)=|{x in x̅|xⱼ=NA}|/|x̅| This method is referred to as fRand.

Since the synthetic datasets are generated using data generator models such as GANs, to compare the proposed methods in a systematic way, β is given in terms of S_{x̅}. In addition, four assumptions about the data generator model used, such as GANs, are given as follows.

Let x̅˜ [symbol] (X), i.e., sampled i.i.d. from the original data distribution, [symbol] (X); and let [symbol] _{x̅}(X|m)= [symbol] (X|M=m) be the distribution learned via GAN when trained on the dataset x̅ₘ.
1) Given x̅ₘ has sufficient support (e.g., |x̅ₘ|≥τ), [symbol] _{x̅}(X|m) is quite close to the original distribution [symbol] (X|m), where closeness of these distribution is measured via some appropriate metric.
2) When x̅m has insufficient support, [symbol] _{x̅}(X|m) is much farther from [symbol] (X|m) compared to when x̅ₘ has sufficient support.
3) The farther [symbol] _{x̅}(X|m) is from [symbol] (X|m), the more dissimilar is the dataset generated by GAN. Namely, if [symbol] _{x̅}(X|m) is farther from [symbol] (X|m) than [symbol] _{x̅}(X|m), then

$$𝒲 ( {\overline{x}}_{m} , {\overline{x}}_{m}^{′} ) \leq 𝒲 ( {\overline{x}}_{m} , {\overline{𝓏}}_{m}^{′} ) , where {\overline{x}}_{m}^{′} ∼ {ℙ}_{\overline{{x}_{m}}} ( X \vert m ) and {\overline{z}}_{m}^{′} ∼ {ℙ}_{\overline{𝓏}} ( X \vert m ) .$$

4) For any m≠m* such that x̅ₘ and x̅ₘ_{^{*}} have sufficient support,

$$𝒲 ( {\overline{x}}_{m} , {\overline{x}}_{m}^{′} ) \leq 𝒲 ( {\overline{x}}_{{m}^{*}} , {\overline{x}}_{{m}^{*}}^{′} ) , where {\overline{x}}_{{m}^{*}}^{′} ∼ {ℙ}_{\overline{x}} ( X \vert {m}^{*} ) and {\overline{x}}_{m}^{′} ∼ {ℙ}_{\overline{x}} ( X \vert m ) .$$

Accordingly extensive empirical evaluation was carried out.

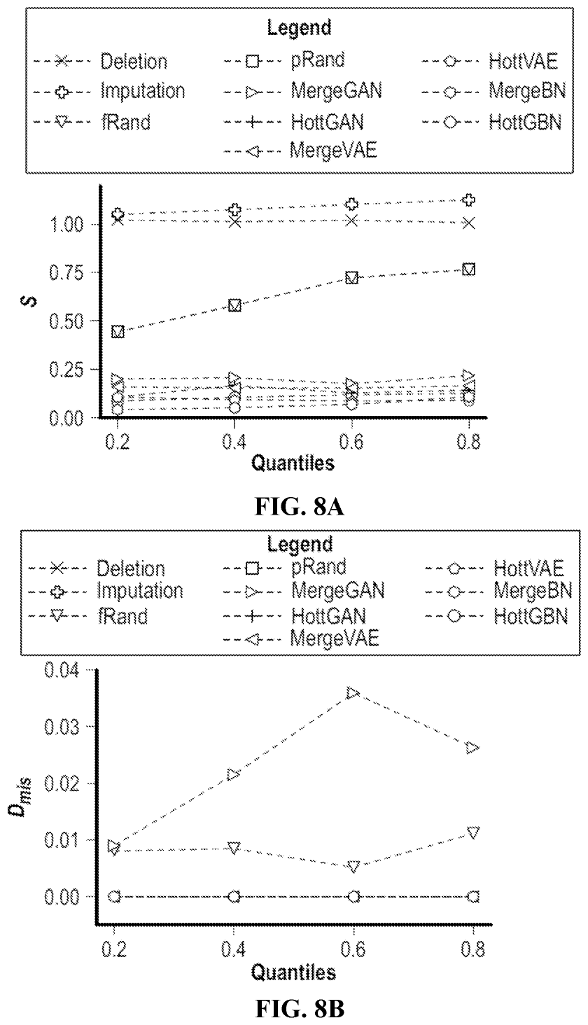

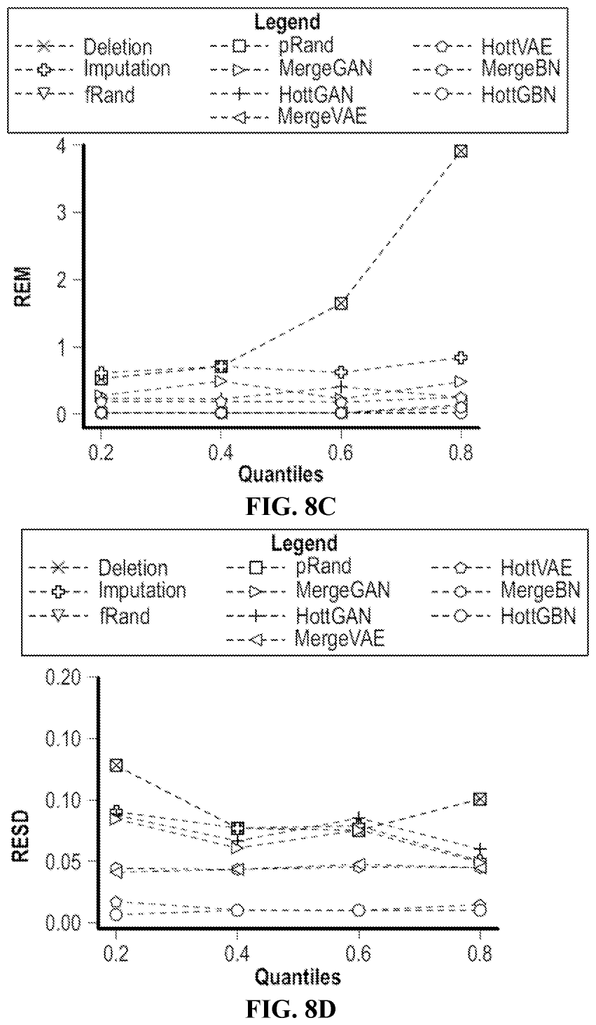

FIGS. 8A-8D depict synthetic data quality of the Gauss 1 dataset, showing comparative plots of the different instantiated methods with respect to similarity S, divergence in mp-distribution Dₘᵢₛ, relative error of mean (REM), and standard deviation (RESD) of the synthetic dataset. Referring to FIGS. 8A-8D, each quantile refers to a different dataset, with different MAR-missingness.

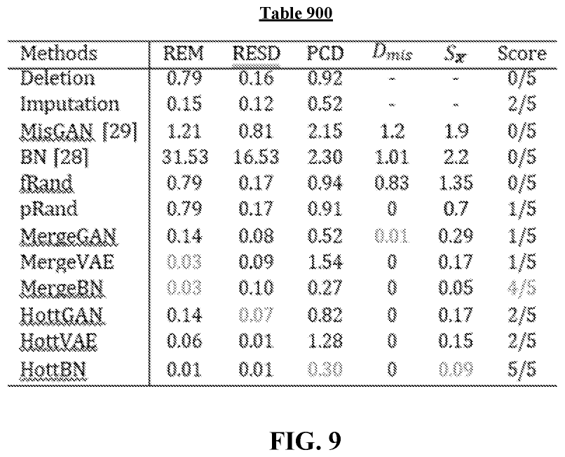

FIG. 9 illustrates a table depicting synthetic data quality for the Gauss 2 dataset. The table 9000 depicts REM, RESD, projected cumulative distribution (PCD), Dₘᵢₛ, similarity (ST), and a Score for each method (e.g., Deletion, Imputation, MisGAN, Bayesian Network, fRand, pRand, MergeGAN, HottGAN, MergeVAE, HottVAE, MergeBN, and HottBN). For each method, the “Score” is given out of 5. The Score indicates the number of metrics per which that method is among the top 2 (smallest numbers). For example, it can be seen that for REM in the Gauss 2 dataset, HottBN is the best method and MergeVAE and MergeBN are tied as the second best.

As can be seen from FIGS. 8A-8D and 9, HottBN demonstrates the most favorable performance on Gauss 1, followed by MergeBN, HottVAE, and HottGAN; and the methods such as fRand, pRand, and MisGAN, that rely on MCAR assumption consistently generate poor quality data under MAR-missingness. The trends in the results for the Gauss 2 dataset are similar and the error in estimating the original correlation matrix (PCD, which is computed as the Frobenius norm of the difference of the original and estimated correlation matrices) can also be seen in table 9000. The results show that when the missingness is MAR, generating synthetic data while preserving mp-distribution leads to higher quality synthetic data. Furthermore, under such missingness, HottBN and MergeBN are better options compared to fRand and pRand.

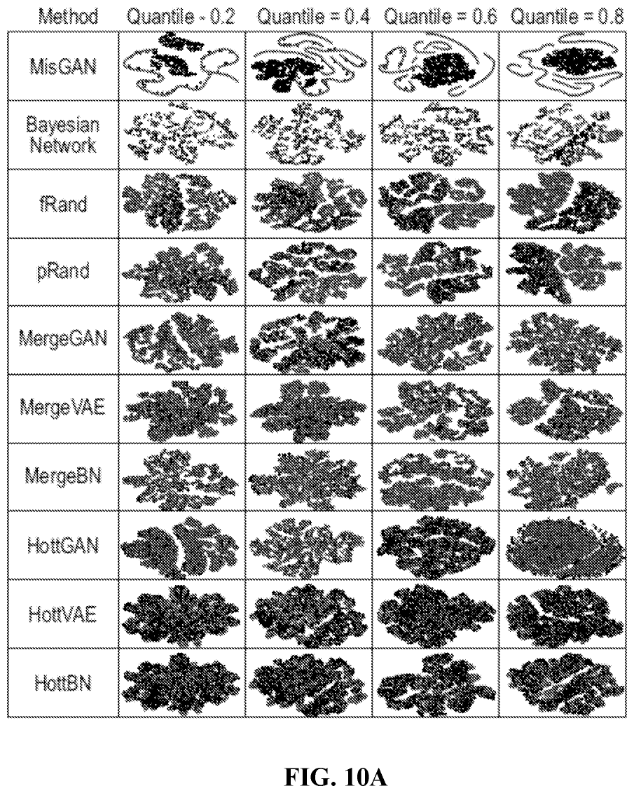

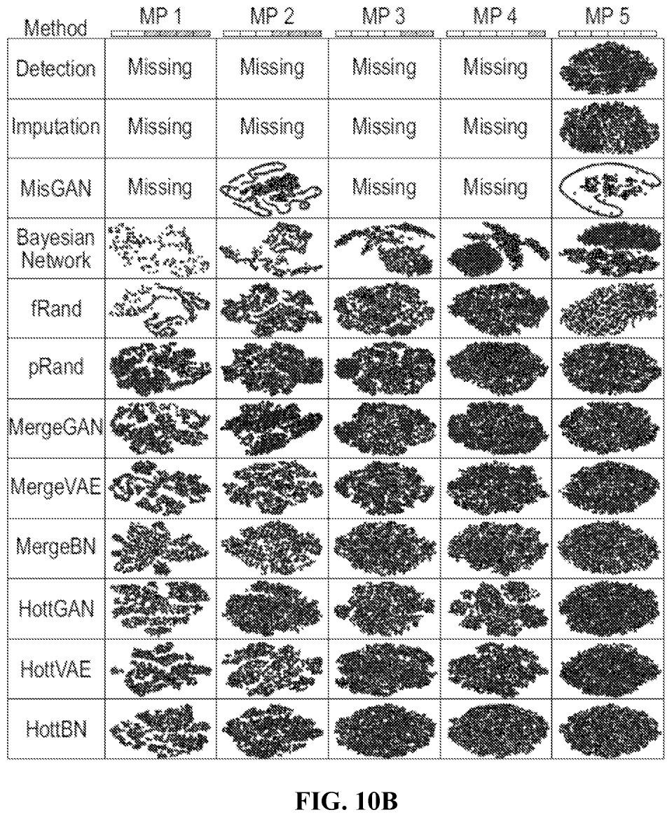

FIGS. 10A and 10B show t-SNE plots for the Gauss 1 and Gauss 2 datasets, respectively, for each method and dataset that is given by quantile. Each plot gives a “scatterplot” projection of original dataset (squares) and synthetic dataset (circles) for each method (e.g., Deletion, Imputation, MisGAN, Bayesian Network, fRand, pRand, MergeGAN, HottGAN, MergeVAE, HottVAE, MergeBN, and HottBN). FIG. 10A plots results of MPs with feature 2 missing for the different Gauss 1 datasets.

Notably, as illustrated by FIGS. 10A and 10B, MisGAN and Bayesian Network are the weakest performing methods, as they failed to learn distribution of the real data (e.g., MisGAN did not generate data for the MP 1, MP 3, and MP 4.

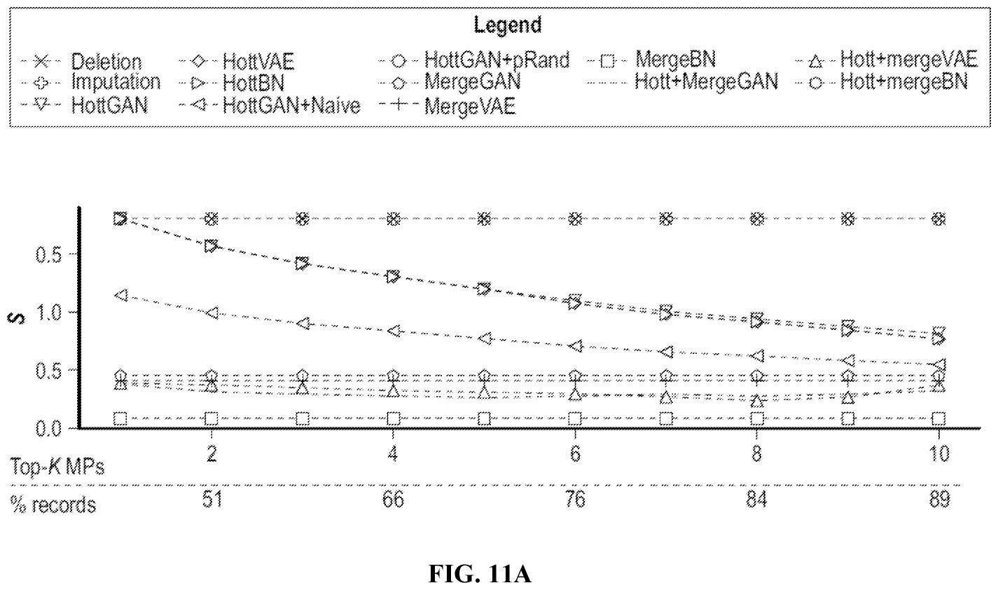

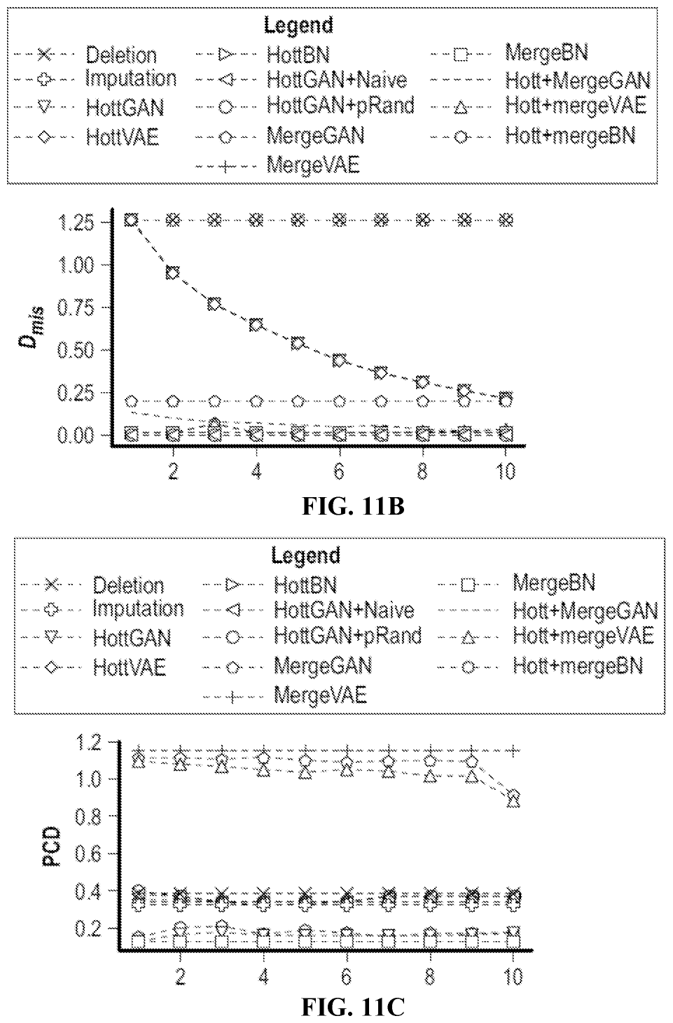

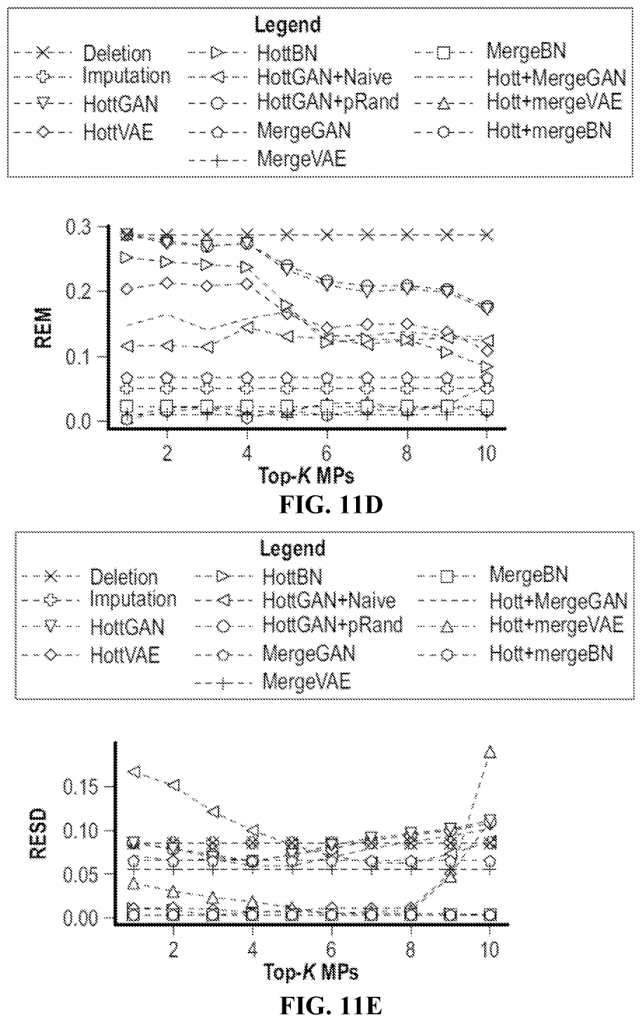

FIGS. 11A-11E depict synthetic data quality of the Gauss 3 dataset, showing comparative plots of the different instantiated methods with respect to similarity S, divergence in mp-distribution Dₘᵢₛ, PCD, REM, and RESD. Referring to FIG. 11A, the horizontal axis gives two values for each tick, the top one provides top-k (i.e., k hot partitions with the highest support) and the bottom one gives the percentage size of top-k. In FIGS. 11B-11E the horizontal axis provides top-k MPs.

Referring to FIGS. 11A-11E, different versions of HottGAN+, HottVAE+ and HottBN+ are compared in terms of data quality and computation time for different volumes of data being processed. The HottGAN, HottVAE, and HottBN are trained over the top-k patterns (i.e., the k hot partitions with the most support) and the corresponding synthetic data is generated. Some of the methods are used to generate synthetic data for the remaining patterns and some of the methods are trained on the entire dataset (e.g., MergeGAN is trained on the entire dataset as the baseline). It can be seen that Hott+MergeBN produces the highest quality datasets consistently, followed by MergeBN and Hott+MergeVAE. Moreover, it can be seen that, in comparison to HottGAN and MergeGAN, Hott+MergeGAN generates synthetic data of better quality with only approximately ⅓ of the training time required by MergeGAN when k=10.

The evaluations of the described methods were conducted on two real world datasets: Price and Brain. Both datasets consist of missing values, which are either MAR or MNAR. The missing rates for Price range from 0.8% to 49.6% and for Brain from 0.002% to 40.98%. Brain has 53 missing patterns, from which the top two are selected (covering 93.3% of the samples).

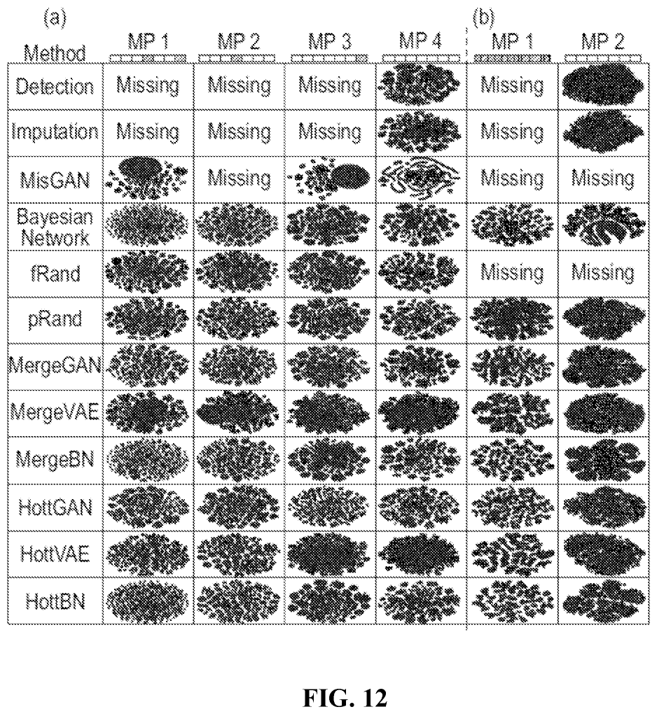

FIG. 12 illustrates a t-SNE Plot obtained from the various instantiated methods for the Price dataset (a) and Brain dataset (b). Each plot gives a “scatterplot” projection of original data (squares) and synthetic data (circles) for each missing pattern (MP) corresponding to each method (e.g., Deletion, Imputation, MisGAN, Bayesian Network, fRand, pRand, MergeGAN, HottGAN, MergeVAE, HottVAE, MergeBN, and HottBN). The higher the overlap between the points representing original data and the points representing synthetic data, the higher the synthetic data quality.

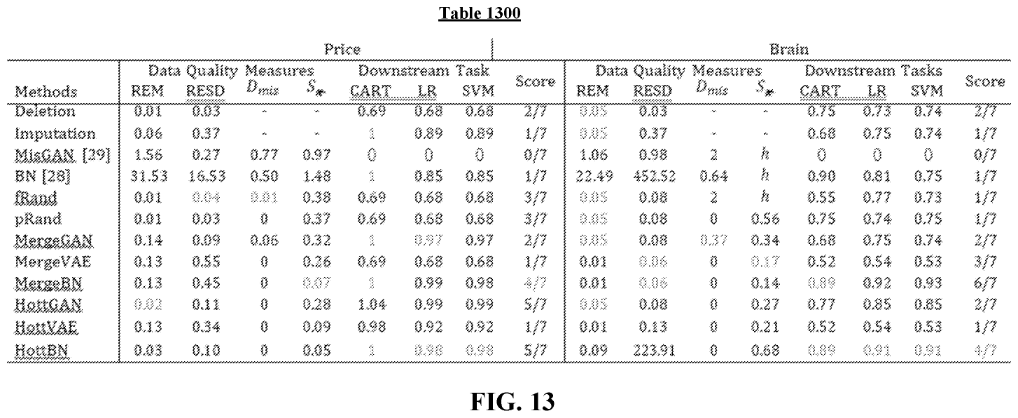

FIG. 13 illustrates a table depicting synthetic data quality obtained from the various instantiated methods for the Price dataset (a) and Brain dataset (b) (e.g., of Price dataset (a) and Brain dataset (b) as illustrated in FIG. 12). Referring to FIG. 13, table 1300 depicts “Data Quality Measures” (e.g., REM, RESD, Dₘᵢₛ, and ST) and “Downstream Tasks” (e.g., CART, LR, SVM, and a “Score”) for each method, including (e.g., Deletion, Imputation, MisGAN, Bayesian Network, fRand, pRand, MergeGAN, HottGAN, MergeVAE, HottVAE, MergeBN, and HottBN) for both the Price dataset (a) and the Brain dataset (b).

Each downstream task analysis (e.g., Downstream Task) was performed on two real datasets. For each dataset, the binary classification task was considered by converting one categorical feature to a binary feature. The performance under Train on Real Test on Synthetic (TRTS) and Train on Synthetic Test on Real (TSTR) frameworks was evaluated. As depicted in FIG. 12, three classifiers, including classification and regression trees (CART), Logistical Regression (LR), and Linear Support Vector Machine (SVM), and calculated the area under ROC curve (AUROC). The AUROC score is scaled to the theoretical infimum (i.e., Train on Real Test on Real) and the average over TRTS and TSTR is reported.

In FIG. 13, the MisGAN method only produced a single value of the target binary variable, therefore, the AUROC is undefined. Therefore, 0 is used to depict its worst performance, h depicts a high value of S when the number of MPs in the generated data are way more than the number of MPs in the real data and no (or fewer) samples have the MPs present in the real data.

Referring to FIGS. 12 and 13, HottGAN, MergeGAN, and pRand achieve similar performance on Brain dataset (b) in terms of t-SNE, REM, and RESD. Synthetic data generated by HottGAN achieves lower S-values and higher scores for downstream tasks except for CART, as shown in FIG. 13. MergeBN and HottBN are the best performing methods. Regarding the Price dataset (a), synthetic data generated by HottBN, HottGAN, and MergeBN are better quality, as shown by t-SNE in FIG. 12.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of generating synthetic data, comprising:
receiving data having missing elements;
evaluating the data for patterns with respect to the missing elements;
labeling the data according to the patterns;
generating labeled synthetic data using the labeled data; and
inserting blanks into the labeled synthetic data according to associated labels of the labeled data to generate synthetic data with corresponding missing elements.

2. The method of claim 1, further comprising applying the synthetic data with the corresponding missing elements as training data for a machine learning algorithm.

3. The method of claim 1, wherein the data is tabular data.

4. The method of claim 1, wherein the data comprises a set of samples.

5. The method of claim 4, wherein labeling the data according to the patterns comprises applying a label indicating a pattern to each sample in the set of samples independently.

6. The method of claim 5, further comprising imputing values for the missing elements of data before generating the labeled synthetic data.

7. The method of claim 4, further comprising grouping the samples of the set of samples into groups before labeling the data according to the patterns, wherein each group comprises samples with identical patterns with respect to the missing elements.

8. The method of claim 7, wherein labeling the data according to the patterns comprises applying a label indicating a pattern with respect to the missing elements to each group.

9. The method of claim 8, wherein generating labeled synthetic data using the labeled data comprises generating separate sets of labeled synthetic data corresponding to each labeled group.

10. The method of claim 1, wherein generating labeled synthetic data comprising using a generative adversarial network (GAN), Bayesian Network (BN), or a Variational Auto-encoder (VAE).

11. A computer-readable storage medium having instructions stored thereon that, when executed by a processing system, perform a method of generating synthetic data, comprising:
receiving data having missing elements;
evaluating the data for patterns with respect to the missing elements;
labeling the data according to the patterns;
generating labeled synthetic data using the labeled data; and
inserting blanks into the labeled synthetic data according to associated labels of the labeled data to generate synthetic data with corresponding missing elements.

12. The medium of claim 11, wherein the data comprises a set of samples.

13. The medium of claim 12, wherein labeling the data according to the patterns comprises applying a label indicating a pattern to each sample in the set of samples independently,
wherein the method further comprises imputing values for the missing elements of data before generating the labeled synthetic data.

14. The medium of claim 12, wherein the method further comprises:
grouping the samples of the set of samples into groups before labeling the data according to the patterns,
wherein each group comprises samples with identical patterns with respect to the missing elements,
wherein labeling the data according to the patterns comprises applying a label indicating a pattern with respect to the missing elements to each group, and
wherein generating labeled synthetic data using the labeled data comprises generating separate sets of labeled synthetic data corresponding to each labeled group.

15. The medium of claim 11, wherein generating labeled synthetic data comprises using a generative adversarial network (GAN), Bayesian Network (BN), or a Variational Auto-encoder (VAE).

16. A system comprising:
a processing system;
a storage system; and
instructions stored on the storage system that, when executed by the processing system, direct the processing system to:
receive data having missing elements;
evaluate the data for patterns with respect to the missing elements;
label the data according to the patterns;
generate labeled synthetic data using the labeled data; and
insert blanks into the labeled synthetic data according to associated labels of the labeled data to generate synthetic data with corresponding missing elements.

17. The system of claim 16, wherein the data comprises a set of samples.

18. The system of claim 17, wherein the instructions to label the data according to the patterns direct the processing system to apply a label indicating a pattern to each sample in the set of samples independently, wherein the instructions further direct the processing system to impute values for the missing elements of data before generating the labeled synthetic data.

19. The system of claim 17, wherein the instructions further direct the processing system to:
group the samples of the set of samples into groups before labeling the data according to the patterns,
wherein each group comprises samples with identical patterns with respect to the missing elements,
wherein labeling the data according to the patterns comprises applying a label indicating a pattern with respect to the missing elements to each group, and
wherein generating labeled synthetic data using the labeled data comprises generating separate sets of labeled synthetic data corresponding to each labeled group.

20. The system of claim 16, wherein the instructions to generate labeled synthetic data direct the processing system to use a generative adversarial network (GAN), Bayesian Network (BN), or a Variational Auto-encoder (VAE).
